(19) United States
(12) Patent Application Publication
(10) Pub. No.: US 2007/0248915 A1
(43) Pub. Date: Oct. 25, 2007

(54) METHOD FOR MANUFACTURING PATTERNED THIN-FILM LAYER

(75) Inventors: Ching-Yu Chou, Hsinchu (TW); Yu-Ning Wang, Hsinchu (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: ICF Technology Co., Ltd., Hsinchu (TW)

(21) Appl. No.: 11/614,026

(22) Filed: Dec. 20, 2006

(30) Foreign Application Priority Data
Apr. 21, 2006 (TW) 95114372

(51) Int. Cl. B05D 5/00; G03C 5/00

(52) U.S. Cl. 430/311; 427/256

(57) ABSTRACT

A method for manufacturing a patterned thin-film layer includes: providing a substrate having a plurality of banks on the substrate, with the banks and the substrate cooperatively defining a plurality of accommodating spaces; depositing ink having a solvent with high boiling temperature into each of the accommodating spaces using at least two nozzles; and solidifying the ink in each of the accommodating spaces to form the patterned thin-film layer on the substrate. The method can achieve a uniform thickness thin-film layer.

### BACKGROUND

1. Technical Field

The present invention generally relates to methods for manufacturing film layers on a substrate, and more specifically to a method for manufacturing patterned thin-film layer on a substrate.

2. Description of Related Art

At present, methods for manufacturing patterned thin-film layer on a substrate include photolithographic methods and ink-jet methods.

The photolithographic method is described as below: applying a photoresist layer on a substrate; exposing the photoresist layer using a photo mask with a predetermined pattern and developing the exposed photoresist layer to form a predetermined patterned thin-film layer. However, a complex process is needed in the photolithographic method and a utilization ratio of the photoresist material is low so that a manufacturing cost is high.

The ink-jet method uses an ink-jet device for depositing ink into a predetermined position on a substrate. A patterned thin-film layer is formed after solidifying the ink.

In a conventional ink-jet method, a number of banks are formed on the substrate and a number of accommodating spaces are defined by the banks with the substrate. Ink can be deposited into each of the accommodating spaces and solidified to form the patterned thin-film layer. However, ink in each accommodating space has different content. Therefore, thickness of resulting thin-film layers in the accommodating spaces will be unsatisfactorily uneven.

What is needed, therefore, is a method for manufacturing a patterned thin-film layer with a uniform thickness.

### SUMMARY

In an embodiment, a method for manufacturing patterned thin-film layer includes: providing a substrate having a plurality of banks on the substrate, the banks and the substrate cooperatively defining a plurality of accommodating spaces; depositing ink having a solvent with high boiling temperature into each of the accommodating spaces using at least two nozzles; and solidifying the ink in each of the accommodating spaces to form the patterned thin-film layer on the substrate.

Other advantages and novel features will become more apparent from the following detailed description of the present method for manufacturing patterned thin-film layer when taken in conjunction with the accompanying drawings.

### BRIEF DESCRIPTION OF THE DRAWINGS

Many aspects of the method for manufacturing patterned thin-film layer can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

FIG. 1 is a schematic cross-sectional view of one stage of a method for manufacturing patterned thin-film layer on a substrate, in accordance with a first embodiment of the present invention, namely the substrate being provided.

FIG. 2 is similar to FIG. 1, but showing a number of banks formed on the substrate shown in FIG. 1 and a number of accommodating spaces defined by the banks.

FIGS. 3 to 4 are schematic views of a step of depositing ink into each of the accommodating spaces in accordance with the first embodiment.

FIGS. 5 to 8 are schematic views of a step of depositing ink into each of the accommodating spaces in accordance with a second embodiment.

FIGS. 9 to 12 are schematic views of a step of depositing ink into each of the accommodating spaces in accordance with a third embodiment.

FIG. 13 is similar to FIG. 2, but showing a patterned thin-film layer formed on the substrate shown in FIG. 1.

FIG. 14 is similar to FIG. 13, but showing a transparent layer formed on the patterned thin-film layer shown in FIG. 13.

### DETAILED DESCRIPTION OF PREFERRED EMBODIMENT

Reference will now be made to the drawings to describe the preferred embodiments of the present method for manufacturing a patterned thin-film layer in detail. The method includes following steps:

providing a substrate,

forming a plurality of banks formed thereon, the banks and the substrate cooperatively defining a plurality of accommodating spaces;

depositing ink having a solvent with high boiling temperature into each of the accommodating spaces using at least two nozzles; and

solidifying the ink in each of the accommodating spaces to form the patterned thin-film layer on the substrate.

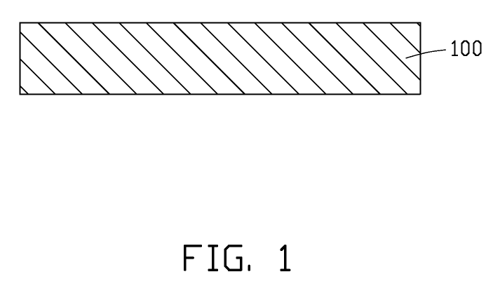

In step 1, referring to FIG. 1, a substrate 100 is provided. A material of the substrate 100 is selected from the group consisting of glass, quartz, silicon, metal, and plastic.

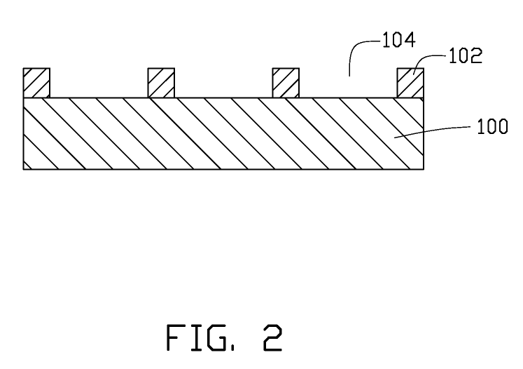

In step 2, referring to FIG. 2, a number of banks 102 are formed on a surface of the substrate 100 and a number of accommodating spaces 104 are cooperatively defined by the banks 102 with the substrate 100. The banks 102 are composed of resin material. The banks 102 may be formed by exposing a photoresist layer on the substrate 100 using a photo mask with a predetermined pattern and developing the photoresist layer.

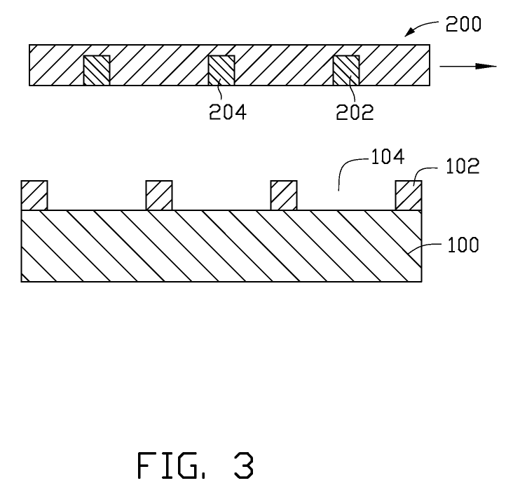

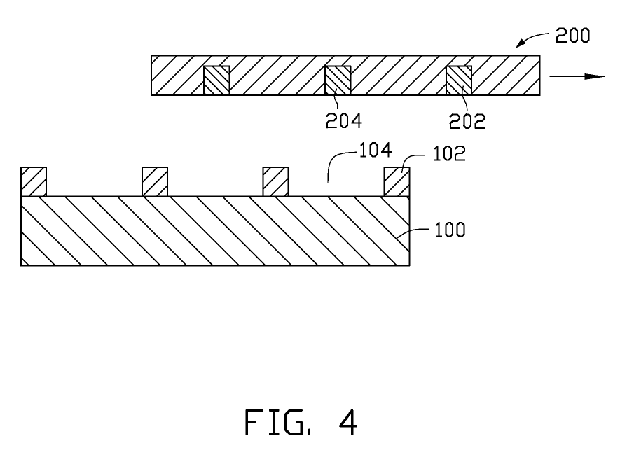

In step 3, referring to FIGS. 3 and 4, ink is deposited into each of the accommodating spaces 104 using at least two nozzles 202 and 204 of an ink-jet head 200.

The ink should have a solvent with high boiling temperature. For example, the boiling temperature of the solvent is more than 170 degrees centigrade (° C.), preferably, more than 185 degrees centigrade. In such a case, the ink deposited in the accommodating space by one of the two nozzles 202 and 204 will not be solidified before the ink deposited by the other nozzle of the two nozzles 202 and 204 reaching the same accommodating space. The ink can be mixed and be solidified at the same time.

An exemplary process for depositing ink into an accommodating space 104 is described as follows. The nozzles 202 and 204 of the ink-jet head 200 align parallel with the substrate 100 so that the nozzle 202 deposits ink into the accommodating space 104, then the ink-jet head 200 is moved horizontally in a direction denoted with an arrow shown in FIG. 3, and the nozzle 204 deposits ink into the accommodating space 104.

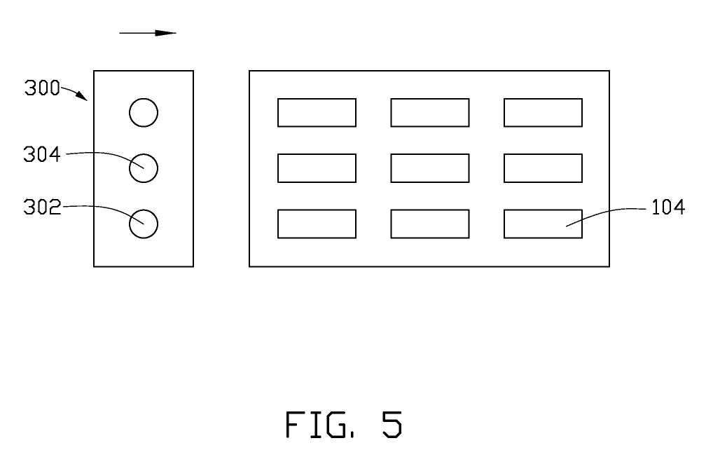

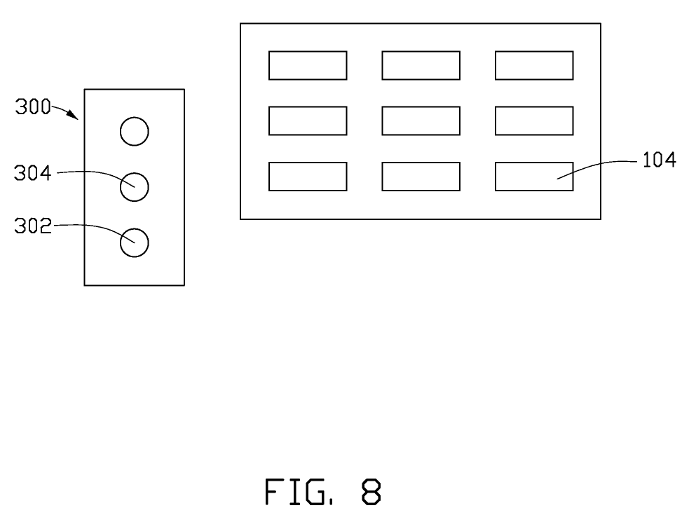

Referring to FIGS. 5 to 8, a second embodiment of the step 3 is described as follows. An ink-jet head 300 deposits ink into a number of accommodating spaces 104 and at least two nozzles 302, 304 of the ink-jet head 300 deposit ink into a same accommodating space 104.

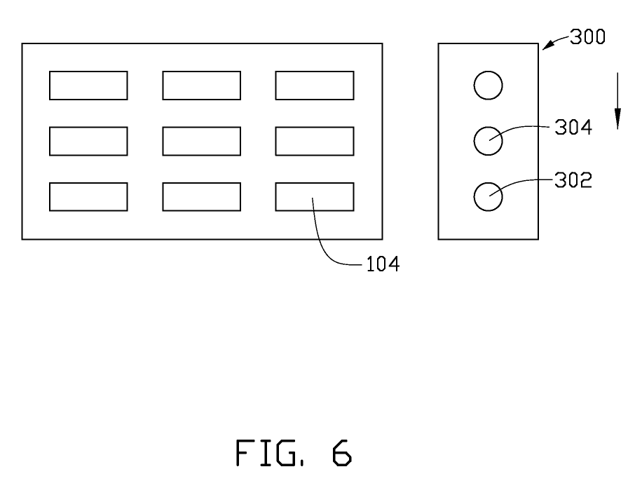

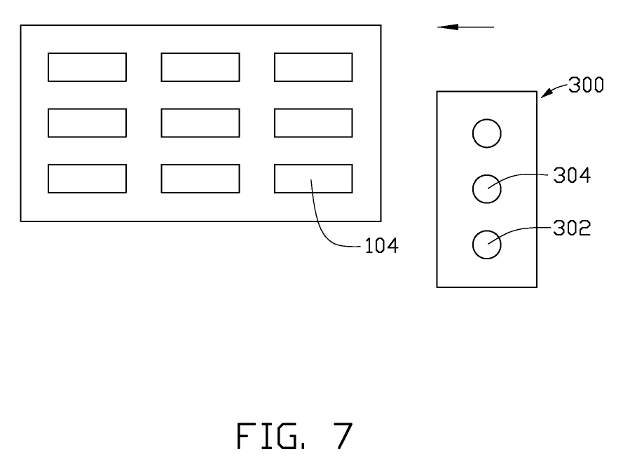

The ink-jet head 300 aligns parallel with the substrate 100 and moves along a first direction denoted with an arrow shown in FIG. 5 and then the nozzle 302 deposits ink into the accommodating space 104. The ink-jet head 300 keeps moving along the first direction. After the ink-jet head 300 moves to the right side of the accommodating space 104, the ink-jet 300 moves along a second direction denoted with an arrow shown in FIG. 6 perpendicular to the first direction until the nozzle 304 and the accommodating space 104 are on a same straight line parallel with the first direction. The ink-jet head 300 moves along a direction opposite to the first direction denoted with an arrow shown in FIG. 7 then the nozzle 304 deposits ink into the same accommodating space 104. After that the ink-jet head 300 keeps moving along the direction denoted shown in FIG. 7. The nozzles 302, 304 of the ink-jet head 300 deposit ink into a next accommodating space 104 until all accommodating spaces 104 are deposited with ink.

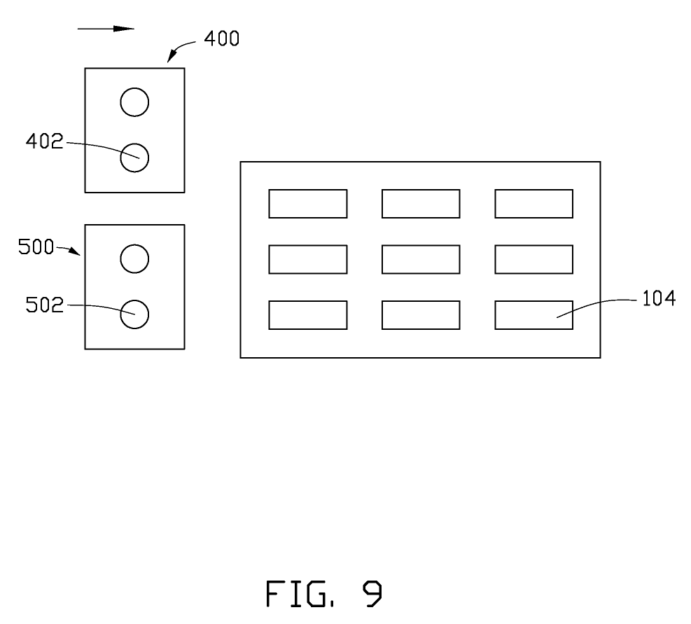

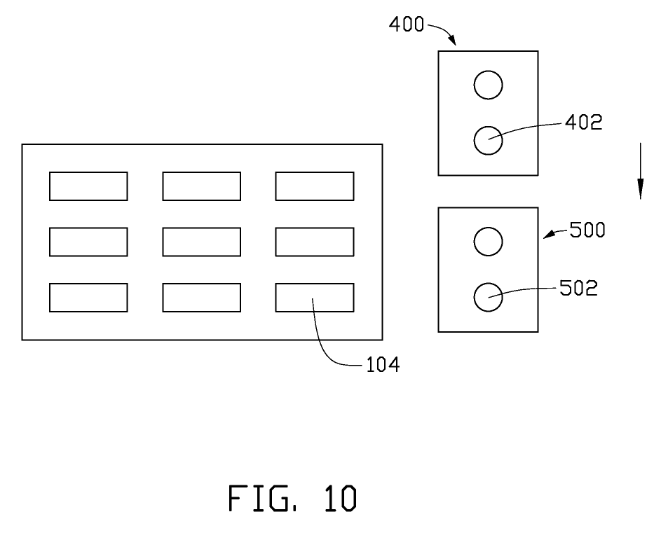

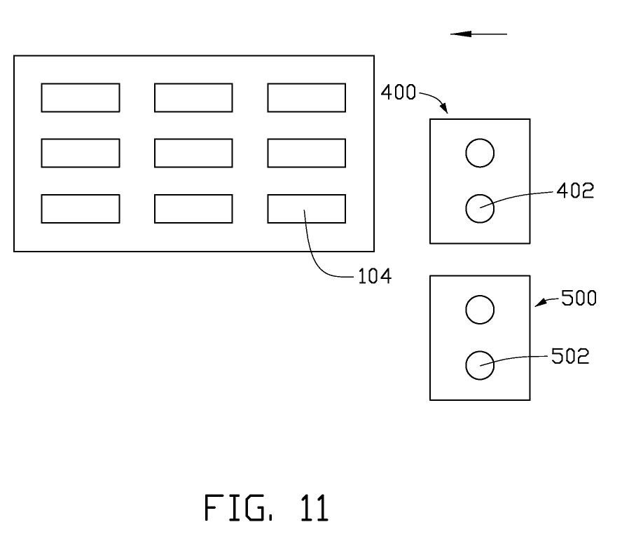

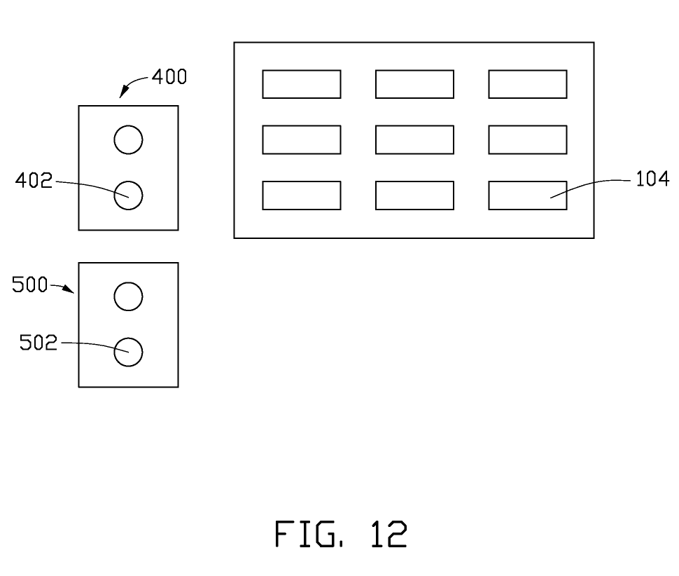

Referring to FIGS. 9 to 12, a third embodiment of the step 3 is described as follows. Two ink-jet heads 400, 500 deposit ink into a number of accommodating spaces 104. The ink-jet head 400 is of an identical type to the ink-jet head 500 and they are arranged on a same ink-jet device. The ink-jet head 400 is spaced a fixed distance from the ink-jet head 500 and the ink-jet head 400 and the ink-jet head 500 are independently movable relative to each other.

A nozzle 402 of the ink-jet head 400 and a nozzle 502 of the ink-jet head 500 deposit ink into an accommodating space 104. The ink-jet head 400 and the ink-jet head 500 are regarded as a single body, the moving of the single body is similar to the moving of the ink-jet head 300. Thus, an accommodating space 104 is deposited by the at least two nozzles 402 and 502.

Alternatively, the ink-jet head 400 can have be of a different type to the ink-jet head 500 and can be arranged on a same ink-jet device. The ink-jet head 400 and the ink-jet head 500 are independently movable relative to each other. Or the ink-jet head 400 and the ink-jet head 500 are on a different ink-jet device.

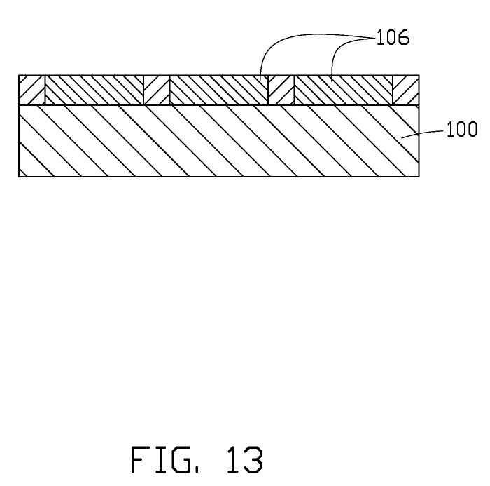

Referring to FIG. 13, in step 4, ink in the accommodating spaces 104 is solidified and a patterned thin-film layer 106 is achieved. Ink in all the accommodating spaces 104 can be solidified using at least one of a vacuum-pumping device, a heating device, and an exposure device. The exposure device can be an ultraviolet light exposure device.

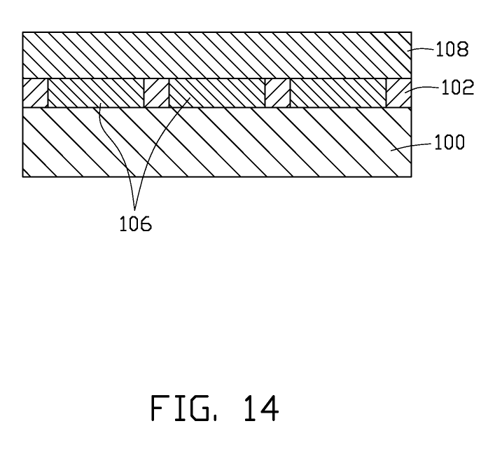

Referring to FIG. 14, in step 5, a transparent layer 108 is configured (i.e., structured and arranged) for covering the banks 102 and the patterned thin-film layer 106. A vacuum sputtering method can be used for sputtering material of indium tin oxide to form the transparent layer 108.

As different nozzles deposit ink at differing rates into an accommodating space, if there are at least two nozzles configured for depositing ink into a same accommodating space the difference between accommodating spaces is lessened. Therefore, the patterned thin-film layer has a uniform thickness.

It should be noted that the method for manufacturing patterned thin-film layer can be used to manufacture devices such as, for example, color filters and organic light emitting display devices. In manufacturing of the color filters, the method can be used to manufacture Red, Green, and Blue color layers. Correspondingly, the bank mentioned above can include single layer bank (using black matrix only as the bank), or multi-layer bank (using black matrix and one or more top layers on the black matrix as the bank). In the manufacturing of an organic light emitting display device, the method can be used to manufacture, for example, emission-material layers, electron-transfer layers, hole-transfer layers and electron-ejection layers.

Although the present invention has been described with reference to specific embodiments, it should be noted that the described embodiments are not necessarily exclusive, and that various changes and modifications may be made to the described embodiments without departing from the scope of the invention as defined by the appended claims.

What is claimed is:

1. A method for manufacturing a patterned thin-film layer, comprising the steps of:
providing a substrate having a plurality of banks formed thereon, the banks and the substrate cooperatively defining a plurality of accommodating spaces;
depositing ink having a solvent with high boiling temperature into each of the accommodating spaces using at least two nozzles; and
solidifying the ink in each of the accommodating spaces to form the patterned thin-film layer on the substrate.

2. The method as claimed in claim 1, wherein a material of the substrate is selected from the group consisting of glass, quartz, silicon, metal, and plastic.

3. The method as claimed in claim 1, wherein a material of the banks is resin material.

4. The method as claimed in claim 1, wherein the banks are formed by the steps of:
applying a photoresist layer on the substrate,
exposing the photoresist layer using a photo mask with a predetermined pattern, and developing the photoresist layer to form a patterned photoresist layer serving as the banks.

5. The method as claimed in claim 1, wherein the at least two nozzles are arranged on a same ink-jet head.

6. The method as claimed in claim 5, wherein the at least tow nozzles comprise a first nozzle and a second nozzle, and the step of depositing ink into each of the accommodating spaces using at least two nozzles comprises the steps of:
depositing ink into an accommodating space using the first nozzle;
moving the ink-jet head parallel with the accommodating space; and
depositing ink into the accommodating space using the second nozzle.

7. The method as claimed in claim 5, wherein the at least two nozzles comprise a first nozzle and a second nozzle, and the step of depositing ink into each of the accommodating spaces using at least two nozzles comprises the steps of:
moving the ink-jet head along a first direction;
depositing ink into an accommodating space using the first nozzle;
keeping moving the ink-jet head along the first direction so as to misalign first nozzle with the accommodating space;
moving the ink-jet head along a second direction perpendicular to the first direction so as to align the accommodating space with the second nozzle in the first direction;
moving the ink-jet head along a third direction opposite to the first direction; and
depositing ink into the accommodating space using the second nozzle.

8. The method as claimed in claim 1, wherein the least two nozzles are distributed on a first ink-jet head and a second ink-jet head.

9. The method as claimed in claim 8, wherein the at least two nozzles comprises a first nozzle and a second nozzle respectively arranged on the first ink-jet head and the second ink-jet head, and the step of depositing ink into each of the accommodating spaces using at least two nozzles comprises the steps of:
moving the first ink-jet head and second ink-jet head along a first direction;
depositing ink into an accommodating space using the first nozzle on the first ink-jet head;
moving the first ink-jet head and the second ink-jet head along the first direction so as to misalign the first nozzle on the first ink-jet head with the accommodating space;
moving the first ink-jet head and the second ink-jet head along a second direction perpendicular to the first direction so as to align the accommodating space with the second nozzle on the second ink-jet head in the first direction;
moving the first ink-jet head and the second ink-jet head along a third direction opposite to the first direction so as to align the second nozzle on the second ink-jet head with the accommodating space; and
depositing ink into the accommodating space using the second nozzle on the second ink-jet head.

10. The method as claimed in claim 8, wherein the first ink-jet head and the second ink-jet head are of identical type.

11. The method as claimed in claim 8, wherein the first ink-jet head and the second ink-jet head are of a different type.

12. The method as claimed in claim 8, wherein the first ink-jet head is spaced a fixed distance from the second ink-jet head.

13. The method as claimed in claim 8, wherein the first ink-jet head and the second ink-jet head are independently movable relative to each other.

14. The method as claimed in claim 8, wherein the first ink-jet head and the second ink-jet head are arranged on a same ink-jet device.

15. The method as claimed in claim 8, wherein the first ink-jet head and the second ink-jet head are arranged on different ink-jet devices.

16. The method as claimed in claim 1, wherein the ink-jet head is selected from the group consisting of a thermal bubble ink-jet head and a piezoelectric ink-jet head.

17. The method as claimed in claim 1, wherein the ink is solidified using at least one of a vacuum-pumping device, a heating device, and an exposure device.

18. The method as claimed in claim 17, wherein the exposure device is an ultraviolet light source.

19. The method as claimed in claim 1, further comprising a step of forming a transparent layer configured for covering the banks and the patterned thin-film layer.

20. The method as claimed in claim 1, where the high boiling temperature of the solvent is more than 170 degrees centigrade.

21. The method as claimed in claim 1, where the high boiling temperature of the solvent is more than 185 degrees centigrade.
